(19) United States
(12) Patent Application Publication
(10) Pub. No.: US 2007/0107662 A1
(43) Pub. Date: May 17, 2007

(54) Disposable protective cover for pet beds and other to-be-protected surfaces

(76) Inventors: Donna R. Queen, Richmond, VA (US); Gia L. Owens, Richmond, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/549,291

(22) Filed: Oct. 13, 2006

Related U.S. Application Data
(60) Provisional application No. 60/730,638, filed on Oct. 27, 2005.
(60) Provisional application No. 60/814,624, filed on Jun. 16, 2006.

(51) Int. Cl. A01K 1/035

(52) U.S. Cl. 119/28.5; 119/471

(57) ABSTRACT

Disposable protective covers for pet beds, automobile seats, automotive trunk interiors, furniture and other solid surfaces stay in place, preferably using detachably re-releasable adhesive. Once protected, the protected surface can still be used for its intended purpose by its customary user, such as a pet or person for sifting, sleeping, laying, etc., because the disposable protective cover has a top surface that is pet-friendly or human-friendly, as the case may be. One such disposable protective cover is a relatively-flat two-sided adhesive article, with detachably releasable adhesive on the surface that contacts the pet bed or other surface to be protected and with lighter adhesive on the top surface (and/or other components for retaining dust, dirt, hair, etc.).

### RELATED APPLICATION

This application claims benefit of U.S. provisional application No. 60/730,638 filed Oct. 27, 2005 for “Disposable Cover” and U.S. Provisional Application No. 60/814,624 filed Jun. 16, 2006 for “Disposable Cover”, both by Donna R. Queen and Gia L. Owens.

### FIELD OF THE INVENTION

The present invention generally relates to disposable covers and, more particularly, to disposable covers for household and personal items.

### BACKGROUND

Household and personal items become unsanitary as they become contaminated with and/or stained by dirt, hair, dander, and odor-causing substances, and the like, through natural wear and tear. These conditions are often exacerbated by the presence of companion pets, making the items both unsanitary and offensive.

Although some items can be laundered, the time-consuming task of laundering is inconvenient and problematic. Unzipping, or generally removing the dirty item is often inconvenient and difficult. Further, laundering and/or removing can facilitate transmission of dirt from one place to another, increasing and complicating the task of cleaning. Conventional, reusable covers have the tendency to shrink, unravel and/or never fit the item from which it was removed, particularly after the conventional cover has been cleaned or laundered. Moreover, laundering and drying takes time, during which the item may be rendered useless and/or remain unprotected.

Many contaminants become difficult, or in some instances impossible, to remove from conventional, reusable covers. For instance, pet-related dirt (including, but not limited to, mud, dirt, flea and tick feces, accidental discharges of urine, saliva, gland secretions, and blood) appears to be ubiquitous and complicated to remove from household, personal items, and even automobiles.

Other items, such as upholstered furniture, duvets, comforters, bedspreads and car seats, cannot be easily cleaned or laundered. The damages to these items can become permanent, and the item can be very costly to replace.

Hair presents another problem, because many companion pets shed. All too frequently, the hair is transferred to household furnishings or personal belongings and may not be easily removed by vacuuming and/or laundering. Because of the close proximity with which many people live with their pets, pet hair may be transferred to many items.

Yet another problem is dander. Dander causes mild to severe allergic reactions in many people.

Odor presents another, different problem. Some odors are acquired through outdoor adventures; some result from being human and/or having a pet. Oftentimes, these odors are offensive. In fact, a complaint frequently cited about pet beds is their pervasive and objectionable odor. Frequently, household items, personal items, and automobile interiors can absorb and retain these objectionable odors. Urine, saliva, gland secretions, or residual wetness from dewy grass, ponds, puddles, rain, etc. can also be a problem, whether odor-causing or not, by compromising hygiene and cleanliness and potentially causing permanent damage.

Another consumer concern is the transmission of germs and insects. The prevalence of bed bugs is reportedly increasing, and many people are concerned about the contaminants found within hotel mattresses. They're reluctant to expose their skin to the institutional sheets and blankets. Further, many people are concerned about exposing their young children to the germs and unsanitary conditions of grocery carts, which are shared by many people, used repeatedly throughout the day, and seldom, if ever, cleaned.

Frequently a conventional protective cover is rendered useless when it does not stay stably positioned. For example, hospitals and nursing homes use chuck pads to provide additional protection under patients who are incontinent and/or immobile. If this pad is displaced, it is rendered useless. Frequently caregivers use more than two or three chuck pads per patient to try to prevent this problem—causing considerable expense, redundancy and waste.

By way of background, the following literature is mentioned:

U.S. Pat. No. 4,649,861 (Mar. 17, 1987) to Elkins et al., for “Pet mat”;

U.S. Pat. No. 4,852,517 (Aug. 1, 1989) to Smith et al., for “Insect trapping mat”;

U.S. Pat. No. 5,127,367 (Jul. 7, 1992) to Starowitz, Jr., for “Animal mat”;

U.S. Pat. No. 5,349,965 (Sep. 27, 1994) to McCarver for “Surgical fluid evacuation system”;

U.S. Pat. No. 5,363,804 (Nov. 15, 1994) to McAlister for “Cushion for a household pet”;

U.S. Pat. No. 5,515,811 (May 14, 1996) to McAlister for “Cushion for a household pet”;

U.S. Pat. No. 5,588,393 (Dec. 31, 1996) to Heilborn for “Collapsible pet bed”;

U.S. Pat. No. 5,685,257 (Nov. 11, 1997) to Feibus for “Pet support cushion”;

U.S. Pat. No. 5,709,312 (Jan. 20, 1998), to Lake for “Disposable cover for trash containers”;

U.S. Pat. No. 5,724,911 (Mar. 10, 1998) to McAlister for “Bed for a household pet”;

U.S. Pat. No. 5,784,995 (Jul. 29, 1998) to Willinger for “Pet bed”;

U.S. Pat. No. 5,826,537 (Oct. 27, 1998) to Heilborn for “Collapsible pet bed”;

U.S. Pat. No. 6,044,794 (Apr. 4, 2000) to Raitanen et al., for “Contoured and suspended pet bed”;

U.S. Pat. Publication No. US 2003/0041808 (Mar. 6, 2003) to Wulforst et al., for “Odor absorbing animal bed and method”;

U.S. Pat. No. 6,546,594 (Apr. 15, 2003), to Wills for “Sanitary and disposable covers for use with door knobs and door handles”;

U.S. Pat. No. 6,588,366 (Jul. 8, 2003) to Ranson et al., for “Pet bed”;

U.S. Pat. Publication No. US 2004/0163603 (Aug. 26, 2004) to Newton, for “Multipurpose disposable pet mattress pad cover”;

U.S. Pat. Publication No. US 2004/0216680 (Nov. 4, 2004) to Lamstein for “Pet bed”;

U.S. Pat. Publication No. US 2005/0211175 (Sep. 29, 2005) to Johnson for “Traveling pet bed”;

U.S. Pat. No. 6,966,275 (Nov. 22, 2005) to Whitehill for “Pet bed”;

U.S. Pat. Publication No. US 2006/0005773 (Jan. 12, 2006) to Brown for “One-piece contoured pet bed of molded memory foam”;

U.S. Pat. Publication No. US 2006/0021583 (Feb. 2, 2006) to Jakubowski for “Pet bed including replaceable material”;

U.S. Pat. Publication No. US 2006/0060147 (Mar. 23, 2006) to Appelhans for “Pet bed cover”;

U.S. Pat. Publication No. US 2006/0096543 (May 11, 2006) to Dennis for “Dog bed made from sisal material”;

U.S. Pat. Publication No. US 2006/0112888 (Jun. 1, 2006) to Greenfield for “Pet beds”;

U.S. Pat. Publication No. US 2006/0118051 (Jun. 8, 2006) to Lima for “Fold up pet bed”;

U.S. Pat. Publication No. US 2006/0162664 (Jul. 27, 2006) to Baer for “Pet bedding kit”.

However, despite many conventional attempts, there remains an unmet need for disposable covers that adequately address the problems that the inventors have mentioned above. As one example, better approaches for protecting pet beds and automotive interiors are much wanted.

### SUMMARY OF THE INVENTION

The present invention addresses the above-mentioned problems and provides disposable covers and other products that collect and retain dirt, hair, odor-causing substances, and liquids, while being easy to remove and inexpensive to replace (such as, e.g., layered disposable covers, treated disposable covers, layered and treated disposable covers, disposable pet blankets, etc.)

In this invention, the inventors protect a variety of surfaces from dirt, hair and other pet and human byproducts in a manner that the surface, once protected, remains useable for its intended use and friendly to the intended user. The inventive products which provide the protection are removably secured in place, with the inventive products being separable from the protected surface and separately disposable.

In one embodiment, the invention provides a disposable protective cover for a to-be-protected planar or generally-planar surface (such as, e.g., a pet bed; a bottom surface of a kennel crate; a bottom surface of a kennel at a veterinary establishment or a boarding facility; a bottom surface of a bird cage; a bottom surface of a hamster/gerbil cage; a bottom surface of another animal or reptile cage; a surface within an automobile passenger compartment or within an automotive trunk or cargo area; a surface of an infant or toddler car seat; an exterior surface of a piece of furniture; a seating portion of a wheelchair, personal mobility vehicle, gurney or mattress; a grocery car seat; an exposed surface of a piece of bedding (such as a bedspread or a sheet); a covered or uncovered floor (such as, e.g., within a home or garage); a covered or uncovered ground surface; etc.), comprising: a first exterior surface (preferably comprising a first adhesive that detachably adheres to the to-be-protected surface, such as, e.g., a first adhesive that provides an adhesive force stably positioning the disposable protective cover with respect to the to-be-protected area), the first surface having a surface area at least covering the to-be-protected surface; and a second exterior surface comprising at least one selected from the group consisting of: (a) a second adhesive, (b) a surface that attracts and holds pet-hair, (c) a surface that attracts and holds dander and (d) a surface that attracts and holds dirt. The first surface and the second surface are disposed outwardly from each other.

In another preferred embodiment, the invention provides a method of protecting a to-be-protected-planar or generally-planar surface, comprising: placing a disposable protective cover atop or on the to-be-protected surface, wherein the disposable cover comprises: a first exterior surface that detachably adheres to the to-be-protected surface, the first surface having a surface area covering the to-be-protected surface; and a second exterior surface comprising an adhesive, the second exterior surface having lesser adhesiveness than the first exterior surface; the first surface and the second surface disposed outwardly from each other.

The invention in another preferred embodiment provides a pet bed kit, comprising: a pet bed; at least one inventive disposable protective cover as herein mentioned. In an inventive pet bed kit, for example, a first disposable protective cover is attached to the pet bed and the kit further comprises at least one replacement disposable protective cover.

In the inventive products, methods, and kits, the second exterior surface of the disposable protective cover is, as appropriate for the application, animal-friendly for coming in close and/or prolonged contact with a pet or other cared-for animal, or human-friendly for coming in close and/or prolonged contact with a human, depending on the application. In some embodiments, preferably, the second exterior surface accumulates adherable materials (such as, e.g., pet hair, dander, dirt, dust, foreign matter, etc.).

### BRIEF DESCRIPTION OF THE DRAWINGS

FIGS. 1A-1B are perspective views illustrating layering of an exemplary inventive disposable cover.

FIGS. 2A-2C are top views illustrating a top layer of an exemplary inventive disposable cover.

FIG. 3 is a cross-sectional view of an inventive disposable protective cover in an exemplary embodiment.

### DETAILED DESCRIPTION OF THE PREFERRED EMBODIMENT

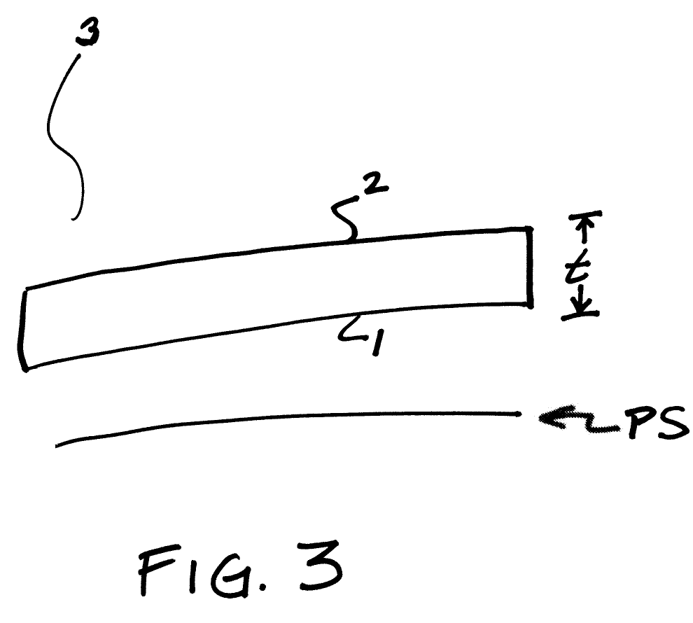

Referring to FIG. 3, there is shown a surface PS which is a planar or generally-planar solid surface, which is what is sought to be protected in the invention. Examples of a to-be-protected planar or generally-planar surface are, for example, a pet bed surface, a furniture surface, an automobile trunk surface, an automotive seat surface, etc. The invention is useable for protecting planar and generally-planar solid surfaces PS.

For providing such protection, an inventive disposable protective cover 3 is shown, which is customized for its application so that the cover 3 is appropriate for and non-damaging to the surface PS that the cover 3 will be covering and further is appropriate for contact with the ordinary user who will be using the underlying article of which the surface PS is a part. By taking into account the underlying article (having the surface PS) and the user of that underlying article, the present inventors are able to provide customized protective covers 3 with outward-facing surfaces 1, 2 (FIG. 3). It therefore will be appreciated that the invention provides a variety of different disposable protective covers, such as, e.g., disposable protective covers for use with short-haired pets, disposable protective covers for use with long-haired pets, disposable protective covers for use on cloth surfaces, disposable protective covers for use on leather surfaces, etc.

A “cover” or “protective cover” refers to an article or product which in regular usage remains in one place for a substantial period of time. A “protective cover” excludes, for example, cleaning products such as, e.g., mops or cleaning sheets (see, e.g., U.S. Pat. No. 6,305,046 (Oct. 23, 2001), U.S. Pat. No. 6,484,346 (Nov. 26, 2002) and U.S. Pat. No. 6,651,290 (Nov. 25, 2003) all to Kingry et al. (The Procter & Gamble Co.), for “Cleaning implements having structures for retaining a sheet”; U.S. Pat. No. 6,797,357 (Sep. 28, 2004) to Fereshtehkhou et al. (The Procter & Gamble Co.), for “Three dimensional structures useful as cleaning sheets”) which in their regular usage are actively and intentionally generally moved about. In the invention, the protective cover 3 is secured to the surface PS for a substantial period of time, such as, e.g., preferably days, weeks, months, with the times of being secured depending on the application.

Referring to FIG. 3, the inventive disposable protective cover 3 is shown before application onto a to-be-protected planar or generally-planar surface PS (such as a surface of a pet bed, an interior automotive surface, an automobile trunk surface, etc.). The cover 3 comprises a first exterior surface 1 and a second exterior surface 2 with the first surface 1 and the second surface 2 disposed outwardly from each other.

Unlike many existing covers for various surfaces, the inventive cover 3 stays in place on the surface PS because of first exterior surface 1. Most preferably, first exterior surface 1 comprises a first adhesive that detachably adheres to the to-be-protected surface PS, the first surface 1 having a surface area at least covering the to-be-protected surface. For providing a surface having a detachable adhesive, which can be re-released without residue or destruction of that to which it was applied, known methods may be used for surface formation. See, e.g., U.S. Pat. No. 6,180,166 (Jan. 30, 2001) to Wood, et al.; U.S. Pat. No. 7,101,615 (Sep. 5, 2006) to Luhmann, et al. (Tesa AG), without being limited thereto. Preferably, for an adhesive used in surface 1, once the cover 3 is in place secured to the surface PS, the adhesive is detachable from the to-be-protected surface PS by application of a level of force administered by a human who is a household consumer and/or pet owner of no special strength, without leaving residue or damage to the surface PS.

The inventive cover 3 further comprises a second exterior surface 2. Most preferably, surface 2 comprises an adhesive (such as, e.g., a low tack, non-transferable pressure sensitive adhesive). Surface 2 differs from surface 1. Surface 2 is often used in applications where a pet or human rests, sits, etc. thereon, meaning that surface 2 should be pet-friendly or human-friendly, depending on the application. The suffix “-friendly” used herein, such as “pet-friendly” or “human-friendly”, refers to a well-tolerated surface and requires general non-toxicity and lack of noxiousness (when used in close and extended direct contact) taking into account the majority of humans or pets, as the case may be, permitting only at most a small number of allergies or problem reactions in individuals or very small sub-populations of users. A “pet-friendly” or “human-friendly” surface requires not only lack of observable noxiousness to a pet or human in close contact with the surface, but also requires absence of known but disguised toxicity to the pet or human. For example, a pleasant-smelling surface containing a known carcinogen would not be considered pet-friendly or human-friendly. When an adhesive is used in the surface 2, the adhesive should be light enough not to cause discomfort to a pet or human user sitting, sleeping, resting, laying, etc. on the surface 2. For example, an adhesive surface strong enough to forcibly detach hair from a pet would be too strong for use as surface 2.

Preferably the exterior surface 2 comprises an attractant to dust, dirt, dander and other particles and/or a surface that is impervious to moisture.

Various construction methods may be used for manufacturing an article with outwardly-facing, different surfaces 1 and 2, where the surfaces 1 and 2 are as provided above. The distance between the surfaces 1, 2, i.e., the thickness t of the disposable cover 3, i.e., is not particularly limited and the cover may have a minimal thickness (as in a thickness of tape) or may include additional layers and/or components adding to its thickness. In most applications, the thickness t of the cover 3 preferably is less (most preferably, substantially less than) than the height of the article whose surface the cover 3 is protecting.

The cover 3 (FIG. 3) may contain a variety of optional components and/or layers, such as, e.g., a hydrophilic material, a moisture barrier, an odor controlling component, a pet-attracting pheromone; and others mentioned in the examples below, and combinations thereof.

The weight of a disposable protective cover 3 is not particularly limited. In a preferred example, the cover 3 has a basis weight of approximately at least 1.8 oz/square yard.

The material of the disposable protective cover 3 is not particularly limited. In a preferred example, the cover 3 includes a woven or non-woven cellulosic or synthetic fabric sheet. The disposable protective cover 3 optionally may include a combination of raised regions, semi-raised regions and compressed regions, the raised regions having a lower fiber density relative to the semi-raised regions, and the semi-raised regions having a lower fiber density relative to the compressed regions.

Examples are as follows, without the invention being limited to the examples.

### INVENTIVE EXAMPLE 1 (DISPOSABLE COVERS)

A disposable cover of this example is commonly used, for example, as a disposable pet device cover, car seat cover, disposable pet throw/blanket, and the like. The disposable cover of this example collects and retains dirt, hair, odor-causing substances, and liquids, is easy to remove, and inexpensive to replace.

Preferably, the inventive disposable cover of this example is a non-woven fiber sheet, wherein a top surface is adapted to attract and retain particles and contaminants, and a bottom surface is treated to adhere to the item being protected.

In another preferred embodiment, the disposable cover comprises at least two layers. The top layer includes a dimensional non-woven fiber that attracts and retains particles and contaminants. The top layer may incorporate an odor-elimination mechanism, such as sporeated beneficial bacteria, sodium bicarbonate, activated charcoal, and the like. The top layer also may include one or more pheromones to cause a specific response by a species. Beneath the non-woven fiber is a moisture barrier layer, which resists liquid penetration. Preferably, at peripheral edges of the disposable cover, the moisture barrier layer is adapted to retain fluids in or on the disposable cover. The bottom layer is treated with a pressure-sensitive, invisible, non-transferable tackifier, or similar agent, to secure the disposable cover to the item being protected.

The disposable cover enables easy replacement of existing covers with a maintenance free product. Quickly, inexpensively, and efficiently, the present invention enables users to remove an existing soiled cover, and easily replace it with a clean one.

The disposable cover of this Example may be sewable, although the non-woven fiber does not require hemming on raw or exposed edges. As a result, the manufacturing costs are low.

### INVENTIVE EXAMPLE 1A

This inventive example 1A particularly provides a disposable cover for household, personal, and automotive items (“items” in this Example 1A). The invention, however, is not limited to its use as a disposable cover for items. Rather, the invention can be used wherever a replaceable device for protecting items is needed or desired, such as, in personal, commercial, and/or industrial environments. The disposable cover of this example can also find utility as a cover for a variety of substrates that would benefit from protection from a variety of contaminants.

The materials described in this example as making up the various elements of the disposable cover are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention, for example.

As used herein, the term “contaminants” includes, but is not limited to: hair; dander; mud; dust; dirt particulates; feces; liquid and moisture; body fluids including urine, saliva, gland secretions, and blood; odors; crumbs; solvents; grease; fertilizer; soil; and the like.

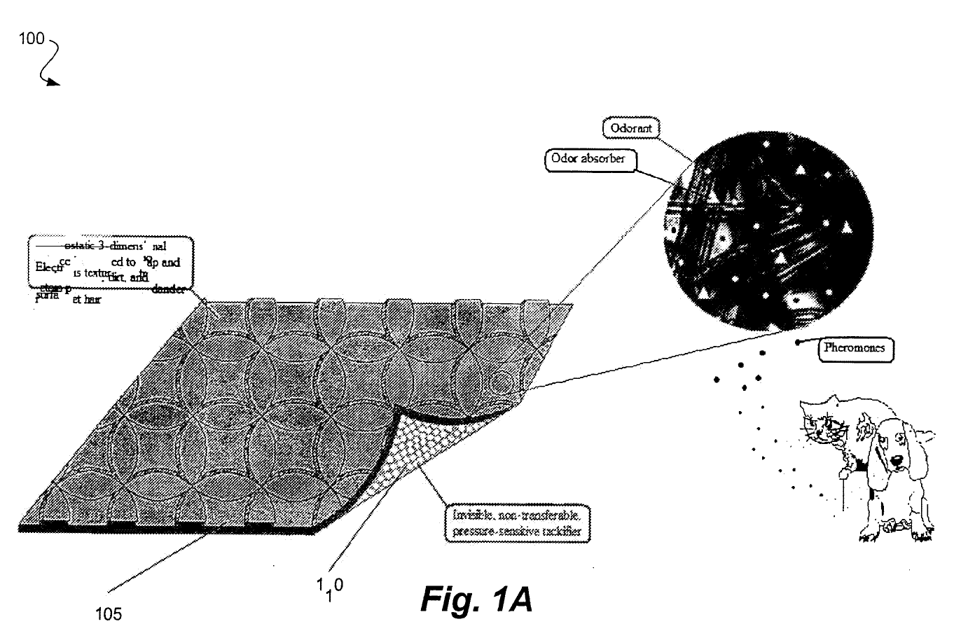

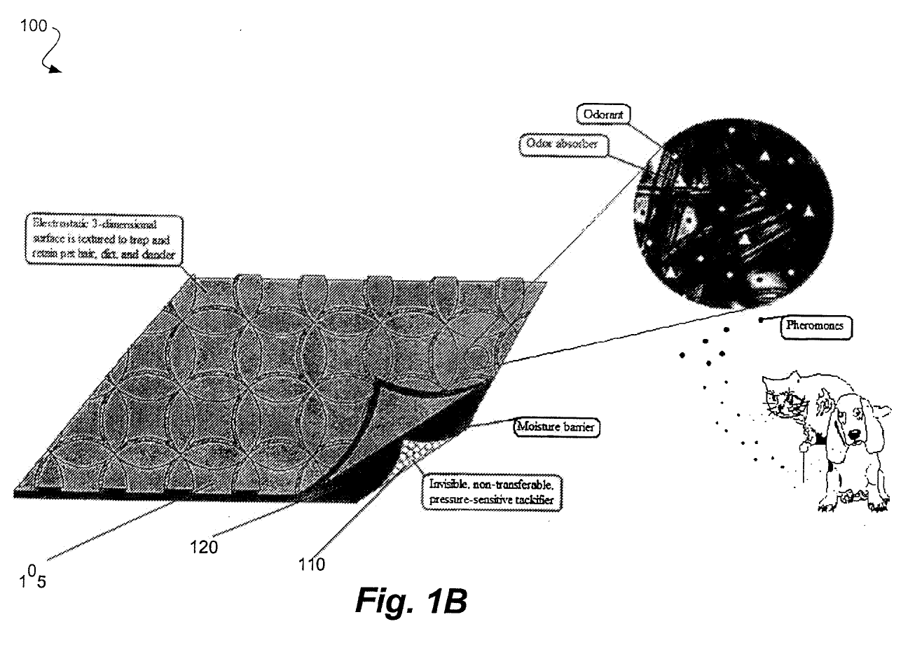

A disposable cover constructed in accordance with a preferred embodiment of the invention can be seen in the perspective view illustrated in FIG. 1A.

FIG. 1A depicts a disposable cover 100. The disposable cover 100 is adapted to improve the collection and removal of contaminants from items. The disposable cover 100 is, for instance, used for applications where moisture absorbency is secondary to the accumulation and retention of dirt, dust, dander, and hair, for example, on car seat covers, pet bed covers, and furniture covers.

The following list of potential uses of the present invention is intended to be illustrative, and not limiting, as the present invention can be used to cover most, if not all, items. For example, in the home, the disposable cover 100 can be used for furniture coverlets, bed coverlets, floor coverlets, garage floor covers; and the like. Also, the disposable cover 100 can be used to line refrigerator dehydrator compartments. Further, the disposable cover 100 can be used on top of, in, and/or under infant high chairs, in strollers, and the like to protect from accidental spills, soils, and/or stains. In automobiles, the disposable cover 100 can be used for car seat covers, infant/toddler seat covers, grocery cart seat covers; and the like. Moreover, the disposable cover 100 can be used to protect the interior, trunk and cargo area, and floor board from miscellaneous dirt and wetness, to simplify clean-up and to prevent permanent damage. For pet-specific products, the disposable cover 100, for example, can be used for pet bed covers, kennel crate liners, bird cage liners, hamster/gerbil cage liners, and the like. For incontinent adults and health care applications, the disposable cover 100, for example, can be used for seat covers for personal mobility vehicles, seat covers for wheel chairs, seat covers for chairs, mattress covers, and the like. The aforementioned items are only an exemplary list of items for which the disposable cover 100 can help reduce, and in some cases eliminate, contaminants. Accordingly, one skilled in the art will appreciate that the disposable cover 100 can be used on many different items, including household items, personal items, within the health care environment and within automobiles.

### INVENTIVE EXAMPLE 1B

In this example, the disposable cover 100 is sewable, but does not require hemming, thereby reducing manufacturing and labor costs. The sewable feature of the cover 100 allows the cover 100 to be produced with elastic or other closure devices, which can be required to secure the disposable cover 100 to certain items. Moreover, the disposable cover 100 of this example is manufactured without threads, and therefore will not unravel. The disposable cover 100 enables extended use, and can resist wear and tear.

### INVENTIVE EXAMPLE 1C

In this example, the disposable cover 100 is permeable, wherein the disposable cover 100 is adapted to breathe, preventing the possibility of ballooning of the disposable cover 100. For instance, in an exemplary embodiment, the disposable cover 100 can be produced with Suprel (registered trademark) by DuPont, which would be particularly appropriate in a health care environment.

### INVENTIVE EXAMPLE 1D

Furthermore, the disposable cover 100 can include textured and electrostatic characteristics, enabling the disposable cover 100 to attract and retain contaminants. Also, the disposable cover 100 is made safe for disposal via typical garbage collection, as the disposable cover 100 can be adapted to have minimal environment impact. In an exemplary embodiment, the disposable cover 100 has biodegradable characteristics, and is biodegradable in a landfill.

### INVENTIVE EXAMPLE 1E

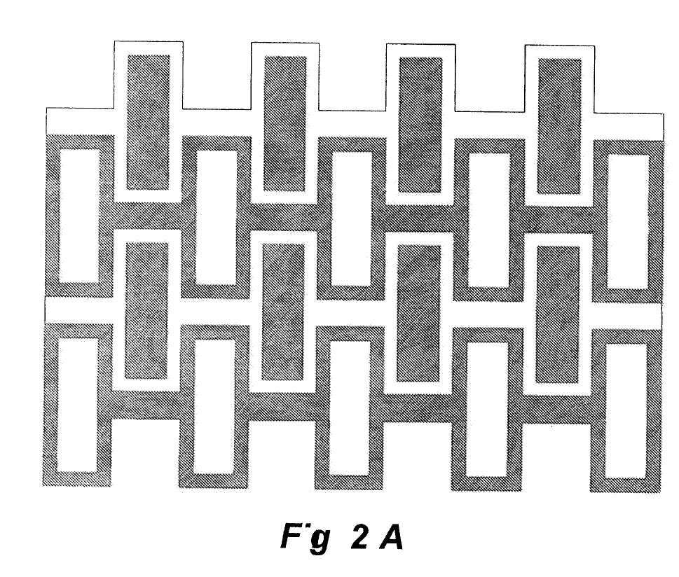

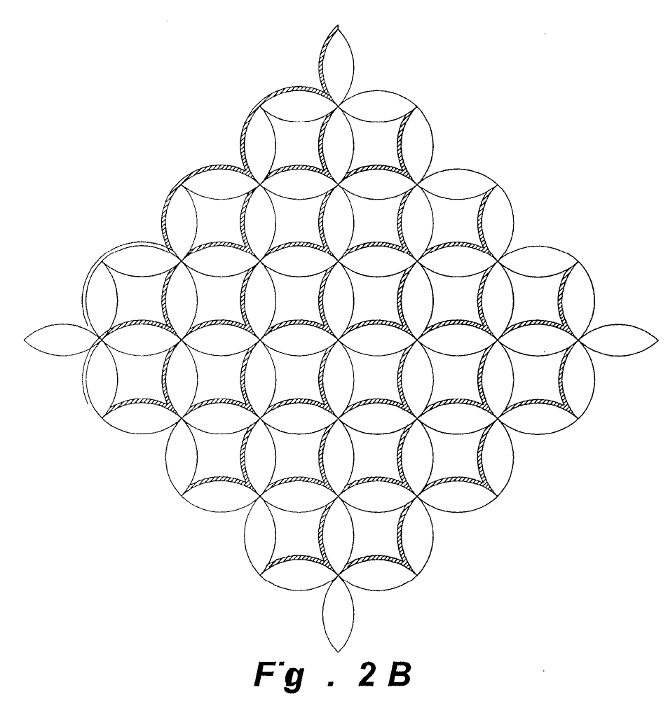

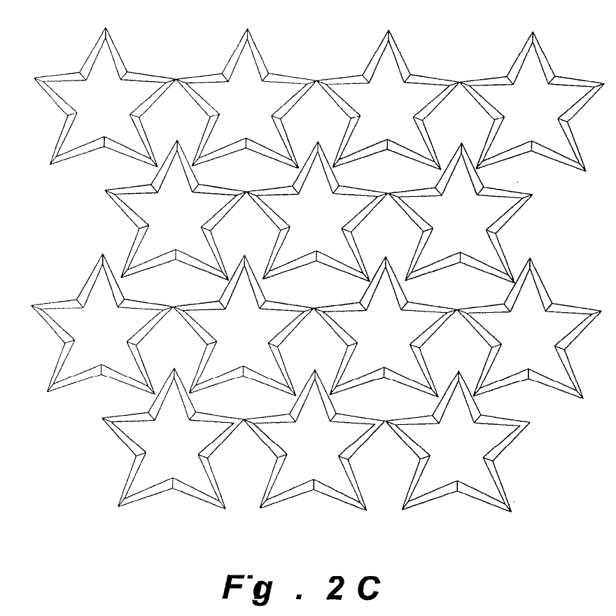

The disposable cover 100 optionally but preferably may include a number of features that enhance its value and superiority over conventional covers. The cover 100 can include a non-woven fiber that includes a three-dimensional (3-D) texture and appearance. Designs for this quilt-like appearance are unlimited, for example, latitudinal, longitudinal, diagonal, cross quilting, web quilting, and the like. These topographical 3-D depressions can trap and retain contaminants, and further improve absorbency. (See, for instance, FIGS. 2A-C).

### INVENTIVE EXAMPLE 1F

Thickness, dimensions, and color of the disposable cover 100 can be manufactured according to the item being protected or for visual appeal. For instance, a disposable pet bed cover can be thinner than a kennel crate liner, because the kennel crate liner can include added absorbency characteristics. The properties of the disposable cover 100 permit varying the thickness, length, width, and color.

In an exemplary embodiment, the dimensions of the disposable cover 100 are proportionately sized according to the item being covered.

### INVENTIVE EXAMPLE 1G

The disposable cover 100 can be secured to the item(s) it protects by many methods, including pressure-sensitive non-transferable tackifier, traditional hook-and-loop closure, drawstrings, pressure sensitive tape, and the like.

For instance, in a preferred embodiment of the present invention, a pressure-sensitive non-transferable invisible tackifier can be added to a posterior surface of the disposable cover 100. This tackifier can serve several purposes, as the tackifier can act to secure the disposable cover 100 on numerous sized and shaped items. Furthermore, the tackifier obviates the need for additional fastening devices, including but not limited to elastic, drawstrings, snaps, buttons, hook-and-loop, etc. The tackifier, moreover, can stabilize the item on the object that is being protected. The disposable cover 100 can be firmly situated to the item via the tackifier. For example, if a pet were to leap onto furniture, bed, car seat or the like, the disposable cover 100 would resist skidding.

Examples of suitable tackifiers include, but are not limited to, aliphatic hydrocarbon resins, aromatic modified aliphatic hydrocarbon resins, hydrogenated polycyclopentadiene resins, polycyclopentadiene resins, gum rosins, gum rosin esters, wood rosins, wood rosin esters, tall oil rosins, tall oil rosin esters, polyterpenes, aromatic modified polyterpenes, terpene phenolics, aromatic modified hydrogenated polycyclopentadiene resins, hydrogenated aliphatic resin, hydrogenated aliphatic aromatic resins, hydrogenated terpenes and modified terpenes, hydrogenated rosin acids, and hydrogenated rosin esters. In some embodiments, the tackifier can be hydrogenated.

Additionally, elastic, drawstrings, hook and loop closures, or pressure sensitive tape can be incorporated into the perimeter of the disposable cover 100 to secure the disposable cover to an item. A piece of elastic can, in a preferred embodiment, be applied by heat fusion. For example, using elastic the disposable cover 100 can operate similar to a large shower cap, enveloping the item to which the disposable cover 100 is attached.

A method chosen to attach the disposable cover 100 preferably provides a secure, non-slip, non-skid environment. The configuration of the disposable cover 100 as illustrated in FIG. 1B can be implemented for applications where moisture absorbency is as important, or more important, than the accumulation and retention of particulates, for example, in kennel crate liners, wheelchair seating covers, cargo/trunk liners, and the like.

### INVENTIVE EXAMPLE 1H

For applications in which the disposable cover 100 can be exposed to potential liquid saturation, the disposable cover 100 can be manufactured with a moisture permeable top layer 105, and a moisture impermeable layer 120, positioned beneath the top layer 105. The edges of the interior surface of the impermeable layer 120 and a bottom layer 110 can overlap, and are preferably joined to the edges of the exterior surface of the permeable top layer 105 to form an enclosure. A separate layer of a moisture absorbent core material can be situated within the enclosure. A purpose of the top layer 105 is to move moisture away from the surface, where it could be absorbed and retained. The leak resistant layer can provide a moisture barrier 120 to protect the items beneath it from moisture.

### INVENTIVE EXAMPLE 1-I

The disposable cover 100 can be packaged and marketed either folded or flat. In another embodiment, the disposable cover 100 can be continuous, perforated sheets rolled around a tubular core, e.g., similar to how paper towels are assembled, permitting ease of dispensing. In yet another embodiment, the disposable cover 100 can be packaged in singles or multiples.

### INVENTIVE EXAMPLE 1J

FIG. 1A illustrates an exemplary perspective view of a disposable cover 100, in accordance with a preferred embodiment of the present invention. The disposable cover 100 comprises a top layer 105 preferably a non-woven fiber sheet for attracting and retaining contaminants and a bottom layer 110. The bottom layer 110 includes a bottom surface, which is preferably treated with a non-transferable tackifier for adhering the disposable cover 100 to the item that the disposable cover 100 is protecting.

The top layer 105 can have a three-dimensional texture, which enhances its ability to attract and retain contaminants, particularly dirt, particulates, dander and hair. The three-dimensional surface treatment can be produced via an air-lay, hot-stamp, or needle-punch process, creating an embossed appearance. A top surface of the top layer 105 can have the appearance of embossing, through a process called calendaring. Calendaring uses heated rollers under pressure to produce a raised design on the fabric surface. A benefit of this embossed texture is to create many cavities to attract and retain contaminants, particularly dirt and fine particulates.

In an exemplary embodiment, the top layer 105 can be made from a combination of ultra-fine polyester and rayon microfibers (or the like). Normally, the combination of the polyester and rayon can be each less than 1/100th thickness of a typical human hair. As one skilled in the art will recognize, microfibers are typically ultra-fine manufactured fibers which can weigh less than approximately 1.0 denier. Currently, there are four types of microfibers being produced, including acrylic microfibers, nylon microfibers, polyester microfibers, and rayon microfibers. Generally, the material for the cover can be made by matting individual fibers together in an interlocking web either mechanically (tangling together) or chemically (gluing, bonding, or melting together). The material can be composed of 100% polyester, or some combination of polyester, rayon, polyethylene, and the like. Polyester is a preferred material as it has high strength (although somewhat lower than nylon), excellent resiliency, a natural electrostatic charge and high abrasion resistance. Because of the low absorbency of polyester, the fiber can quickly dry. Static electricity can be generated by friction over static prone fibers, such as polyester. This electrostatic charge also attracts airborne particles to the charged field, which are then retained by the static electricity. The tight weave of the material is also important to the effectiveness of the disposable cover 100 because dust and dander particles can be smaller than one micron. When the fiber is entangled more than 35,000 hooks and loops/square inch are created, and the non-woven fiber media thereby creates tiny pockets which attract and retain dust, dirt, mites, as well as much larger contaminants such as hair.

The material used to form the non-woven web preferably can be, e.g., fibers such as, e.g., polyester fibers, polyamide fibers, cellulosic fibers, polyolefin fibers, cotton and synthetic fibers, viscose, lyocell, and the like. Suitable polyolefin fibers include, e.g., polypropylene fibers, polyethylene fibers, polybutylene fibers, etc. The non-woven fibers can be formed as a spun-bond web, a thermally bonded carded web, or a web composed of fibers with diameters ranging from about 10 microns to approximately 100 microns.

In a pet bed application, for instance, the disposable cover 100 can be made of material that combines the strength of polyester with the moisture resistance of polyethylene or polypropylene. One skilled in the art will appreciate that the disposable cover 100 can be made of many like materials.

A top surface of the top layer 105 of the disposable cover 100 can also include a surface treatment from a variety of lubricants, such as mineral oil, or petroleum and waxes, such as beeswax. These additives can improve the adherence and retention of the contaminants onto the top surface of the top layer 105 of the disposable cover 100.

The top surface of the top layer 105 of the disposable cover 100 can further include a low tack tackifier, or the like for collecting and retaining hair, dander, and the like.

The bottom surface 110 of the disposable cover 100 can include a more aggressive pressure-sensitive, invisible, non-transferable tackifier resin. The tackifier can be applied, by example, by a spraying or bonding procedure. The bottom surface of the bottom layer 110 of the disposable cover, or that surface that will be in direct contact with the item being protected, such receive the tackifier resin. The tackifier should be strong enough to reduce lateral movement of the disposable cover 100, but weak enough to permit removal of the disposable cover 100 from the item without leaving a residue. Preferably, because disposable covers 100 can be produced on high speed production lines, the tackifier shall offer efficient machinability as well as clean sprayability. The tackifier can be applied to a limited portion of the bottom surface or the entire bottom surface, depending on the application.

There may be used a uniform continuous layer of adhesive, a patterned layer of adhesive, or a combination of separate lines or spots of adhesives. A preferred example is a fluid impervious pressure sensitive adhesive for disposable non-woven products manufactured by Findley Adhesives Company, of Wauwatosa, Wis.

FIG. 1B illustrates another embodiment of the disposable cover 100 with a top surface 105 that is treated to include agents that control, encapsulate, eliminate or mask odors, a moisture barrier layer 120, and an invisible, non-transferable tackifier on the bottom surface of the moisture barrier 120.

The top layer 105, described above, can comprise a non-woven fiber. The non-woven fiber can include odor-control technology or a deodorant. The amount of the deodorant shall be a sufficient quantity to reduce or eliminate odors, and, at the same time, not compromise the structural integrity of the top layer 105. Depending on the agent, the amount of the deodorant can be, for example, between approximately 2-12% of the total weight of the disposable cover 100. In a preferred embodiment of the present invention, the top layer 105 can include at least one absorbent chemical imbedded in and coating the fibers of the porous material.

Moreover, the odor control mechanisms included in the present invention may include sodium bicarbonate (or a related, similar compound), an activated carbon product (charcoal, etc.), odor-eliminating or neutralizing enzyme technology, or other encapsulation technology. These materials are well known for their odor-control properties and are economical. The present invention provides relatively high efficiency by coating the fibers with one or more of the above technologies, as desired. The top layer 105 can also include an odorant to mask offensive odors and provide a pleasant fragrance.

Moreover, the top layer 105 can also be treated with different types of pheromones. Pheromones include substances released by a body of a particular species that can cause a predictable reaction by another individual of the same species. In the present invention, the pheromone can serve, for example, as a specific attractant, and the like. Additionally, the pheromones can reduce fear, apprehension, anxiety, as well as the behavioral and physical consequences associated with stress. For example, if the disposable cover 100 includes pheromones in the top layer 105, pets sleeping on a pet bed covered by the disposable cover 100 could be comforted, relaxed and/or de-stressed, based on the type of pheromone applied in the disposable cover 100.

One skilled in the art will appreciate that many different pheromones can be included in the present invention to trigger different natural reactions by animals and/or mammals. Different compositions and solutions of pheromones can be used to obtain desired reactions. Certain pheromones, for example, can attract and lure animals. This would cause a pet to favor a pet bed with a disposable cover, thereby eschewing other unprotected furniture.

Additionally, the disposable cover 100 may include a barrier layer 120 to prevent the migration of fluids, particulates, and micro-organisms. The barrier layer 120 is adapted to retain any moisture presented/spilled on the disposable cover 100, thereby protecting furnishings from moisture and/or other contaminants that saturate the top layer 105.

The barrier layer 120 is preferably composed of material that can prevent moisture penetration and/or migration. The barrier layer 120, in an exemplary embodiment, can be composed using a polymer or like compound.

The bottom surface of the bottom layer 110 of the disposable cover 100 can include a non-transferable invisible tackifier to stabilize the disposable cover 100. The tackifier can be sprayed on the bottom surface of the bottom layer 110. When a disposable cover 100 is removed from the item, it does not leave residue from the tackifier on the item being protected. The tackifier adheres to the bottom surface of the bottom layer 110, and does not remain on the protected item.

Consequently, the present invention can include a tackifier, which can be sprayed on both the top surface of the cover 100 (to improve attraction and retention of contaminants, such as pet hair, dirt, dander, and the like) and to the bottom surface of the cover 110 (to stabilize the cover on the item).

FIGS. 2A-2C are top views illustrating the top layer of the disposable cover, in accordance with embodiments of the present invention. The top layer 105 of the disposable cover 100 can include the three-dimensional surface for trapping and retaining contaminants. Exemplary embodiments of the top layer 105 are illustrated in FIGS. 2A-2C.

In summary, FIGS. 1A-1B are perspective views illustrating the layering of the disposable cover, in accordance with embodiments of the present invention. The disposable cover 100 depicted in FIG. 1A includes the top surface 105 and the bottom surface 110. The top surface 105 can include an electrostatic 3-D surface adapted to trap contaminants. The top surface 105 can further include a design of the exemplary embodiment as illustrated in FIGS. 2A-C. This surface 105 of the disposable cover 100 can also include odorants and/or pheromones. The odorant can perform like to mask odors on the disposable cover 100. The pheromone can emit a scent to cause a predictable reaction by a pet. The bottom surface includes an invisible, non-transferable, pressure-sensitive tackifier to enable the disposable cover 100 to resist movement.

FIG. 1B includes the same features as illustrated in FIG. 1A, but further includes the moisture barrier to absorb and/or capture moisture that permeates the top layer 105.

As one skilled in the art will appreciate, the disposable cover 100 can be produced with many different colors, widths, basis weights, deniers, levels of absorbency, textures, aperture sizes, fiber compositions, coatings, finishes and textures, odor-control mechanisms, moisture barriers, as determined by the application. The finished material can be cut in predetermined sizes and shapes, or can be supplied in perforated rolls. Also, the disposable cover 100, when sold to the public or through distribution outlets can be packaged individually or packaged in multiples.

### INVENTIVE EXAMPLE 1K

### A Disposable Cover Useful for Protecting Household, Personal, Commercial, Institutional and/or Automotive Items from Contaminants, Waste, Liquids, and the Like

The disposable cover may include a number of materials, including, but not limited to, a top layer with and/or without odor control mechanisms and deodorizing properties, pheromones, a moisture barrier, and a bottom layer treated with a non-transferable tackifier. The top surface attracts and retains contaminants, and is preferably a non-woven fiber. This material may be impregnated with a deodorant to reduce odors, an odorant to mask odors, and/or impregnated with a pheromone for attracting a pet. The moisture barrier layer is an impermeable layer to protect the item from moisture. The bottom surface of the bottom layer includes a pressure-sensitive, invisible, non-transferable tackifier for adhering the disposable cover to the item being protected. Consequently, the disposable cover provides a replaceable, economical cover for protecting items from many contaminants.

### EXAMPLE 2

The invention also provides for a system for effectively marketing and displaying the disposable protective covers to consumers. In this example, a disposable protective cover 3 (FIG. 3) is packaged in packaging that communicates information in a consumer-readable format about the surface PS on which the particular cover 3 contained therein may and/or may not be applied, along with information about the intended users to come in contact with the surface 2. For example, a packaging for a pheromone-containing disposable cover designed for dogs may display: “INTENDED FOR DOGS—contains dog-specific pheromones” and “APPLICABLE TO COTTON, DENIM, VINYL OR LEATHER—not intended for application to silk”.

### EXAMPLE 3

Optionally, in certain applications, a disposable cover may include an additive such as a lotion, aloe, skin/coat treatment, etc. Also, optionally there may be included a medicinal treatment, such as, e.g., an anti-allergy treatment, such as, e.g., an anti-allergy treatment for dog allergies. For example, surface of a disposal cover may be impregnated with a medicinal treatment.

While the invention has been described in terms of preferred embodiments, those skilled in the art will recognize that the invention can be practiced with modification within the spirit and scope of the appended claims.

What we claim is:

1. A disposable protective cover for a to-be-protected planar or generally-planar surface, comprising:
a first exterior surface comprising a first adhesive that detachably adheres to the to-be-protected surface, the first surface having a surface area at least covering the to-be-protected surface; and
a second exterior surface comprising at least one selected from the group consisting of: (a) a second adhesive, (b) a surface that attracts and holds pet-hair, (c) a surface that attracts and holds dander and (d) a surface that attracts and holds dirt;
the first surface and the second surface disposed outwardly from each other.

2. The disposable protective cover of claim 1, wherein the to-be-protected surface is selected from the group consisting of:
a pet bed;
a bottom surface of a kennel crate;
a bottom surface of a kennel at a veterinary establishment or a boarding facility;
a bottom surface of a bird cage;
a bottom surface of a hamster/gerbil cage;
a bottom surface of another animal or reptile cage;
a surface within an automobile passenger compartment or within an automotive trunk or cargo area;
a surface of an infant or toddler car seat;
an exterior surface of a piece of furniture;
a seating portion of a wheelchair, personal mobility vehicle, gurney or mattress;
a grocery cart seat;
an exposed surface of a piece of bedding;
a covered or uncovered floor; and
a covered or uncovered ground surface.

3. The disposable protective cover of claim 1, wherein the first adhesive is detachable from the to-be-protected surface by application of a level of force administered by a human who is a household consumer and/or pet owner of no special strength.

4. The disposable protective cover of claim 1, wherein the second exterior surface is animal-friendly for coming in close and/or prolonged contact with a pet or other cared-for animal.

5. The disposable protective cover of claim 1, wherein the second exterior surface is human-friendly for coming in close and/or prolonged contact with a human.

6. The disposable protective cover of claim 1, comprising a hydrophilic material.

7. The disposable protective cover of claim 1, wherein the first adhesive provides an adhesive force stably positioning the disposable protective cover with respect to the to-be-protected area.

8. The disposable protective cover of claim 1, further including a moisture barrier.

9. The disposable protective cover of claim 1, further including at least one odor controlling component.

10. The disposable protective cover of claim 1, having a basis weight of approximately at least 1.8 oz/square yard.

11. The disposable protective cover of claim 1, wherein the second exterior surface accumulates adherable materials selected from the group consisting of pet hair, dander, dirt, dust and foreign matter.

12. The disposable protective cover of claim 1, including a woven or non-woven cellulosic or synthetic fabric sheet.

13. The disposable protective cover of claim 1, including a combination of raised regions, semi-raised regions and compressed regions, the raised regions having a lower fiber density relative to the semi-raised regions, and the semi-raised regions having a lower fiber density relative to the compressed regions.

14. The disposable protective cover of claim 1, including a low tack, non-transferable pressure sensitive adhesive on a top surface of the protective cover.

15. The disposable protective cover of claim 1, including a top surface comprising an attractant to dust, dirt, dander and other particles and/or a top surface that is impervious to moisture.

16. The disposable protective cover of claim 1, including at least one pet-attracting pheromone.

17. The disposable protective cover of claim 1, wherein the second surface comprises an adhesive.

18. A method of protecting a to-be-protected-planar or generally-planar surface, comprising:
placing a disposable protective cover atop or on the to-be-protected surface, wherein the disposable cover comprises:
a first exterior surface that detachably adheres to the to-be-protected surface, the first surface having a surface area covering the to-be-protected surface; and
a second exterior surface comprising an adhesive, the second exterior surface having lesser adhesiveness than the first exterior surface;
the first surface and the second surface disposed outwardly from each other.

19. A pet bed kit, comprising:
a pet bed;
at least one disposable protective cover for a to-be-protected planar or generally-planar surface of the pet bed, comprising:
a first exterior surface comprising a first adhesive that detachably adheres to the to-be-protected surface, the first surface having a surface area at least covering the to-be-protected surface; and
a second exterior surface comprising at least one selected from the group consisting of: (a) a second adhesive, (b) a surface that attracts and holds pet-hair, (c) a surface that attracts and holds dander and (d) a surface that attracts and holds dirt;
the first surface and the second surface disposed outwardly from each other, wherein the disposable protective cover may be attached to the pet bed or not-yet-attached to the pet bed.

20. The pet bed kit of claim 19, wherein the disposable protective cover is attached to the pet bed and the kit further comprises at least one replacement disposable protective cover.
